(19) United States
(12) Patent Application Publication
(10) Pub. No.: US 2026/0310443 A1
(43) Pub. Date: Oct. 8, 2026

(54) MANAGEMENT DEVICE

(71) Applicant: TOYOTA JIDOSHA KABUSHIKI KAISHA, Toyota-shi (JP)

(72) Inventor: Nobuyuki NAKAGAWA, Miyoshi-shi (JP)

(73) Assignee: TOYOTA JIDOSHA KABUSHIKI KAISHA, Toyota-shi (JP)

(21) Appl. No.: 19/553,865

(22) Filed: Mar. 2, 2026

(30) Foreign Application Priority Data
Apr. 7, 2025 (JP) 2025-063299

(51) Int. Cl. G06F 8/65

(52) U.S. Cl. CPC G06F 8/65

(57) ABSTRACT

The management device is connected to a plurality of nodes in the communication network system through a communication bus (second communication bus), and manages updating of programs stored in the nodes. When the update data of the program is received, the management device switches the speed of communication executed on the communication bus to which the target node, which is a node for updating the program among the plurality of nodes, is connected, to a higher speed. The management device transmits the update data to the target node after switching the communication speed.

### CROSS-REFERENCE TO RELATED APPLICATION

This application claims priority to Japanese Patent Application No. 2025-063299 filed on Apr. 7, 2025. The disclosure of the above-identified application, including the specification, drawings, and claims, is incorporated by reference herein in its entirety.

### BACKGROUND

### 1. Technical Field

The present disclosure relates to a management device.

### 2. Description of Related Art

Japanese Unexamined Patent Application Publication No. 2021-105922 (JP 2021-105922 A) describes a communication network system. The communication network system includes a management device and a plurality of nodes.

The nodes are connected to a plurality of communication buses. The nodes execute communication at different communication speeds through the respective communication buses.

The management device manages updating of a program stored in the nodes. The management device transmits update data in parallel at the same time using the communication buses. This allows the management device to shorten the total time required to update the program.

### SUMMARY

When the management device is connected to the nodes through one communication bus, there is room for contrivance in the method of updating the program in order to shorten the time required to update the program.

In order to address the above issue, there is provided a management device in a communication network system including a plurality of nodes, the management device being connected to the nodes through a communication bus to manage updating of a program stored in the nodes.

When receiving update data of the program, the management device switches a speed of communication executed through the communication bus to which a target node is connected to a higher speed, the target node being a node for which the program is to be updated, among the nodes.

After switching the speed of the communication, the management device transmits the update data to the target node.

The management device described above can shorten the time required to update the program.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a communication network system according to an embodiment;

FIG. 2 is a sequence diagram illustrating aspects of communication performed by the communication network system of FIG. 1 upon receipt of update data;

FIG. 3 is a flowchart showing a flow of a series of processes executed by the reprogramming master ECU of FIG. 1 when determining whether or not to switch the communication rate in the communication bus; and

FIG. 4 is a sequence diagram illustrating an aspect of communication executed by the communication network system of FIG. 1 after the result of the reprogramming is determined.

### DETAILED DESCRIPTION OF EMBODIMENTS

Configuration of the communication network system 30

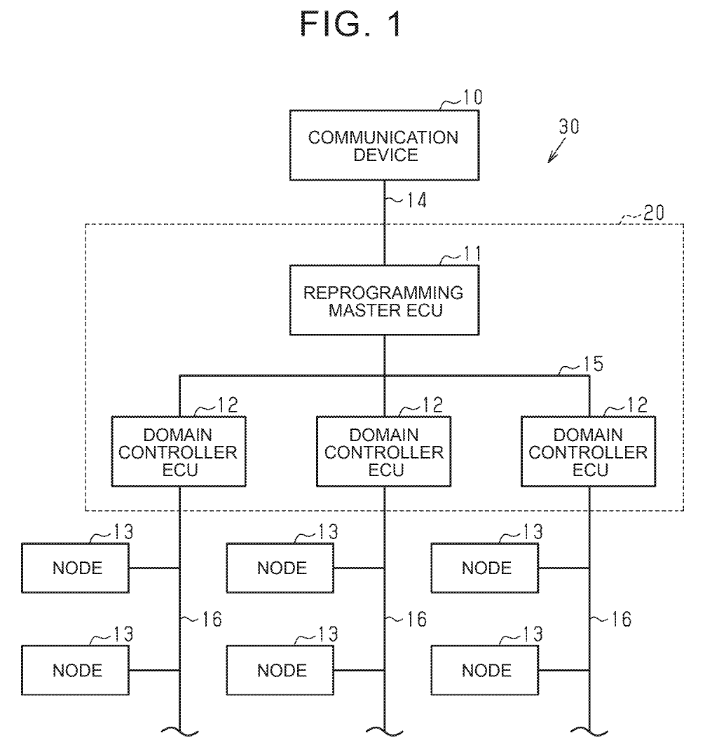

Hereinafter, an embodiment of a management device will be described with reference to FIGS. 1 to 4.

As illustrated in FIG. 1, the communication network system 30 includes a communication device 10, a reprogramming master ECU 11, a domain controller ECU 12, and a plurality of nodes 13. The communication network system 30 is mounted on a vehicle. The reprogramming master ECU 11, the domain controller ECU 12, and the plurality of nodes 13 are electronic control units (Electronic Control Unit) included in the vehicles.

The communication device 10 performs wireless communication with a device such as a server outside the vehicle. The communication device 10 receives the update data of the program of the node 13 by communicating with a device outside the vehicle.

As illustrated in FIG. 1, the reprogramming master ECU 11 and the domain controller ECU 12 constitute a management device 20. The management device 20 manages the reprogramming by the node 13. The reprogramming of the node 13 means that the node 13 updates the program stored therein based on the update data.

As shown in FIG. 1, the reprogramming master ECU 11 is connected to the communication device 10 through a communication cable 14. The communication device 10 and the reprogramming master ECU 11 perform communication according to an Ethernet communication protocol through the communication cable 14, for example. The reprogramming master ECU 11 receives the updated data from the communication device 10 by communicating with the communication device 10 via the communication cable 14.

As shown in FIG. 1, the communication network system 30 includes three domain controller ECU 12. The reprogramming master ECU 11 and the three domain controllers ECU 12 are connected through a first communication bus 15, which is a communication bus. The reprogramming master ECU 11 and the domain controller ECU 12 perform communication according to the communication protocol of CAN-FD (CAN with Flexible Datarate), for example, through the first communication bus 15.

Each domain controller ECU 12 is connected to a plurality of nodes 13 through a second communication bus 16 which is a communication bus. The domain controller ECU 12 and the node 13 perform communication in accordance with, for example, a CAN or CAN-FD communication protocol.

The plurality of nodes 13 in the communication network system 30 constitute a domain that is a group of the nodes 13 according to functions performed in the vehicle. A plurality of nodes 13 belonging to the same domain are connected to one second communication bus 16. The domain controller ECU 12 can communicate with a plurality of nodes 13 belonging to the same domain through a second communication bus 16.

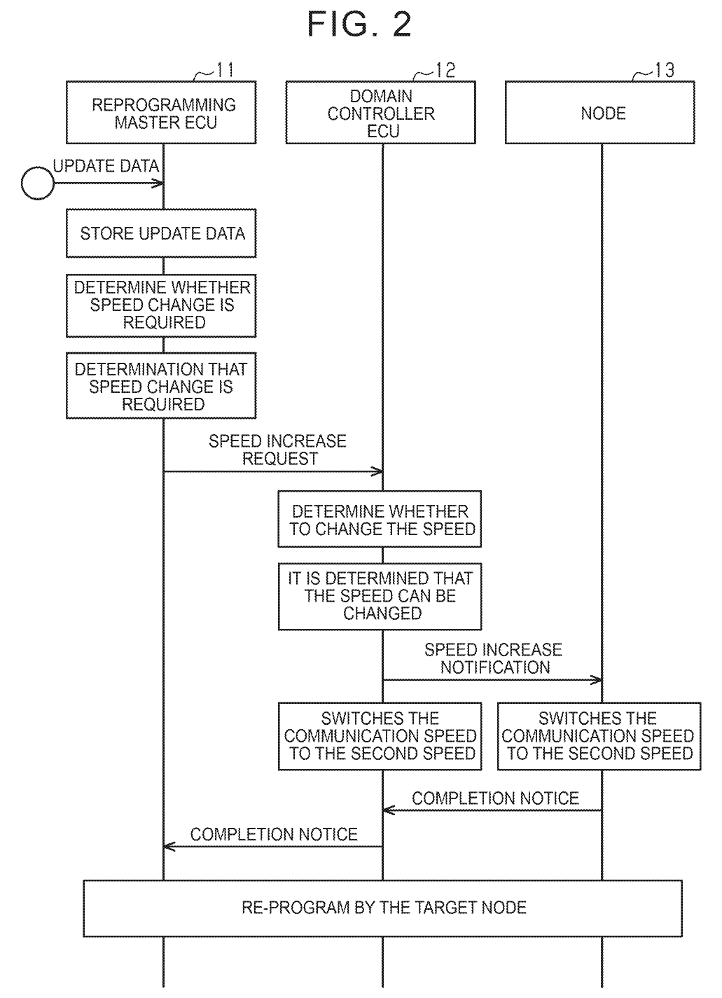

The communication device 10 transmits the received update data to the reprogramming master ECU 11 when the update data of the program of the node 13 is received from the device outside the vehicle. FIG. 2 illustrates aspects of communication performed between the reprogramming master ECU 11, the domain controller ECU 12, and the node 13 after the reprogramming master ECU 11 receives the updated data from the communication device 10.

### Process performed by the reprogramming master ECU 11

As shown in FIG. 2, the reprogramming master ECU 11 stores the received updated data. As shown in FIG. 2, the reprogramming master ECU 11 then determines whether a velocity change is necessary. The speed change in FIG. 2 refers to a change in the speed of communication performed between the domain controller ECU 12 and the node 13.

As will be described later, after receiving the update data from the communication device 10, the reprogramming master ECU 11 transmits the stored update data to the target node via the domain controller ECU 12. The target node is the node 13 of the node 13 in the communication network system 30 that executes the reprogramming based on the update data. In order to increase the execution speed of the reprogramming by the target node, the management device 20 increases the speed of the communication executed on the second communication bus 16 to which the target node is connected.

Hereinafter, the speed of communication executed on the second communication bus 16 before the speed is increased is referred to as a first speed. The first speed is a speed of communication executed in the second communication bus 16 at a normal time.

Hereinafter, the speed of communication executed on the second communication bus 16 after the speed is increased is referred to as a second speed. The second speed is a higher speed than the first speed. For example, when the first rate is the rate of 500 kbps according to CAN communication protocol, the second rate is the rate of 2 Mbps according to CAN-FD communication protocol. For example, the second speed is the speed of CAN-FD communication protocol when the first speed is the speed of 2 Mbps according to 5 Mbps communication protocol.

It is conceivable that the first speed is different for each of the second communication buses 16. For example, it is conceivable that the first rate on the second communication bus 16 on the left side of FIG. 1 is a 500 kbps according to CAN communication protocol. It is conceivable that the first speed on the second communication bus 16 in the middle of FIG. 1 is the speed of 2 Mbps according to CAN-FD communication protocol. Since the second speed is set in accordance with the first speed, when the first speed is different for each second communication bus 16, the second speed is also different for each second communication bus 16.

In FIG. 2, the reprogramming master ECU 11 that stores the updated data determines whether the speed of the communication executed on the second communication bus 16 to which the target node is connected needs to be changed.

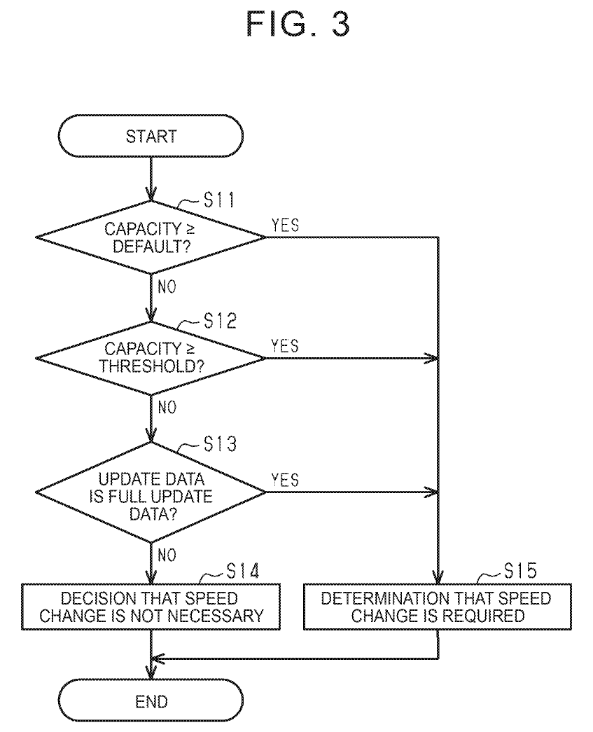

FIG. 3 illustrates a flow of a series of processes executed by the reprogramming master ECU 11 when determining whether or not the speed of communication executed on the second communication bus 16 to which the target node is connected needs to be changed. In FIG. 3, S means a step.

When the series of processes illustrated in FIG. 3 is started, the reprogramming master ECU 11 first executes S11 process. In S11 process, the reprogramming master ECU 11 checks the capacity of the update data and determines whether the capacity of the update data is equal to or larger than a predetermined value. The default value is a value set to determine whether or not the capacity of the update data is large.

In S11 process, when the reprogramming master ECU 11 determines that the size of the updated data is less than the predetermined value (S11: NO), the process proceeds to S12. In S12 process, the reprogramming master ECU 11 checks the capacity of the update data and determines whether the capacity of the update data is equal to or greater than the threshold.

For each speed of communication executed on the second communication bus 16, a threshold value for comparing with the capacity of the update data is determined in advance. For example, in the second communication bus 16 to which the target node is connected, when communication is performed at a 500 kbps rate according to CAN communication protocol, the thresholds are 100 kB. For example, in the second communication bus 16 to which the target node is connected, when communication is performed at a 2 Mbps rate according to CAN-FD communication protocol, the thresholds are 500 kB. As described above, the first speed may be different for each second communication bus 16. In S12 process, the reprogramming master ECU 11 compares the capacity of the updated data with the thresholds corresponding to the first speed on the second communication bus 16 to which the target node is connected.

In S12 process, when the reprogramming master ECU 11 determines that the capacity of the updated data is less than the threshold (S12: NO), the process proceeds to S13. In S13 process, the reprogramming master ECU 11 checks the content of the update data and determines whether or not the update data is full update data.

There are two types of update data: full update data and differential update data. The full update data is update data that causes the target node to perform the full update of the program. The difference update data is update data that causes the target node to partially update the program.

In S13 process, when the reprogramming master ECU 11 determines that the update data is not full update data but differential update data (S13: NO), the process proceeds to S14. In S14 process, the reprogramming master ECU 11 determines that it is not necessary to change the speed of the communication executed on the second communication bus 16 to which the target node is connected. Thereafter, the reprogramming master ECU 11 ends the series of processes illustrated in FIG. 3. When the reprogramming master ECU 11 executes S14 process, the management device 20 causes the target node to execute the reprogramming without switching the communication speed on the second communication bus 16 to which the target node is connected from the first speed to the second speed.

In S11 process, when the reprogramming master ECU 11 determines that the size of the updated data is equal to or larger than the predetermined value (S11: YES), the process proceeds to S15. In S12 process, the reprogramming master ECU 11 also advances the process to S15 when it is determined that the capacity of the updated data is equal to or larger than the threshold (S12: YES). In S13 process, the reprogramming master ECU 11 also advances the process to S15 when it is determined that the update data is full update data (S13: YES).

In S15 process, the reprogramming master ECU 11 determines that the speed of the communication executed on the second communication bus 16 to which the target node is connected needs to be changed. Thereafter, the reprogramming master ECU 11 ends the series of processes illustrated in FIG. 3. When the reprogramming master ECU 11 executes S15 process, the management device 20 switches the communication speed of the second communication bus 16 to which the target node is connected from the first speed to the second speed, and causes the target node to execute the reprogramming.

In the case illustrated in FIG. 2, the reprogramming master ECU 11 determines that the speed of the communication executed on the second communication bus 16 to which the target node is connected needs to be changed. As shown in FIG. 2, after determining that the communication speed needs to be changed, the reprogramming master ECU 11 transmits a speed increasing demand to the domain controller ECU 12. The speed increase request is a request for switching the speed of communication executed on the second communication bus 16 to which the target node is connected from the first speed to the second speed. The reprogramming master ECU 11 transmits a rate-increasing demand to the domain controller ECU 12 connected to the target node through the second communication bus 16 among the three domain controller ECU 12 included in the communication network system 30.

### Process performed by the domain controller ECU 12 and the node 13

As illustrated in FIG. 2, the domain controller ECU 12 that has received the speed increasing request determines whether the speed of the communication executed on the second communication bus 16 to which the target node is connected can be changed.

For each speed of communication executed on the second communication bus 16, an upper limit value of the number of devices that can be communicated on one communication bus is determined. When the number of devices connected to the communication bus exceeds the number of devices capable of communicating at the second speed, communication at the second speed may not be realized even when the communication speed is switched.

The domain controller ECU 12 checks how many nodes 13 are connected to the second communication bus 16 to which the target node is connected. When the number of the nodes 13 is smaller than the upper limit value corresponding to the second speed, the domain controller ECU 12 determines that the speed of the communication executed on the second communication bus 16 to which the target node is connected can be changed. When the domain controller ECU 12 determines that the communication speed can be changed, the management device 20 switches the communication speed from the first speed to the second speed and causes the target node to execute the reprogramming.

On the other hand, when the number of the nodes 13 is equal to or greater than the upper limit value corresponding to the second speed, the domain controller ECU 12 determines that the speed of the communication executed on the second communication bus 16 to which the target node is connected cannot be changed. When the domain controller ECU 12 determines that the communication speed cannot be changed, the management device 20 causes the target node to execute the reprogramming without switching the communication speed from the first speed to the second speed.

In the case illustrated in FIG. 2, the domain controller ECU 12 determines that the speed of the communication executed on the second communication bus 16 to which the target node is connected can be changed. As illustrated in FIG. 2, the domain controller ECU 12 that has determined that the communication speed can be changed transmits a speed increasing notification to the node 13. The speed increase notification is a notification indicating that the speed of communication executed on the second communication bus 16 is switched from the first speed to the second speed. The domain controller ECU 12 sends a speed-up notification to all nodes 13 connected to the second communication bus 16, including the target node.

As shown in FIG. 2, after transmitting the speed increasing notification, the domain controller ECU 12 switches the speed of communication that it executes through the second communication bus 16 from the first speed to the second speed.

As illustrated in FIG. 2, the node 13 that has received the speed increase notification switches the speed of communication that it executes through the second communication bus 16 from the first speed to the second speed. As illustrated in FIG. 2, the node 13 then transmits a completion notification indicating that the switching of the communication rate is completed to the domain controller ECU 12.

All the nodes 13 connected to the domain controller ECU 12 and the second communication bus 16 switch the communication speed from the first speed to the second speed. As a result, the speed of communication executed on the second communication bus 16 is switched from the first speed to the second speed.

The domain controller ECU 12 switches its communication speed from the first speed to the second speed. At the same time, the domain controller ECU 12 transmits a completion notification to the reprogramming master ECU 11 when receiving the completion notification from all the nodes 13 connected to the second communication bus 16. At this time, the completion notification transmitted by the domain controller ECU 12 indicates that the switching from the first speed to the second speed has been completed with respect to the speed of the communication executed on the second communication bus 16.

As illustrated in FIG. 2, after the reprogramming master ECU 11 receives the completion notification, the reprogramming by the target node is started.

When the reprogramming by the target node is executed, the reprogramming master ECU 11 transmits the updated data stored therein to the domain controller ECU 12. Upon receiving the update data from the reprogramming master ECU 11, the domain controller ECU 12 transmits the update data to the target node through the second communication bus 16. The target node that has received the update data from the domain controller ECU 12 updates the program stored in the target node based on the update data.

### Communication aspects based on reprogramming results

When the reprogramming is executed by the target node after the communication speed is switched from the first speed to the second speed, the reprogramming master ECU 11 determines the reprogramming.

The target node receives all the update data required for the reprogramming from the reprogramming master ECU 11, and when the update of the program is completed, transmits a completion notification indicating that the update is completed to the reprogramming master ECU 11. When receiving the completion notification from the target node, the reprogramming master ECU 11 determines that the reprogramming by the target node has succeeded.

In some cases, communication between the target node and the domain controller ECU 12 at the second rate is not successful, and the target node cannot receive the updated data. In this case, the target node cannot update the program and cannot transmit the completion notification. The reprogramming master ECU 11 determines that the reprogramming by the target node has failed when the completion notification is not received from the target node even after a predetermined period of time has elapsed after all the updated data stored in the target node has been transmitted.

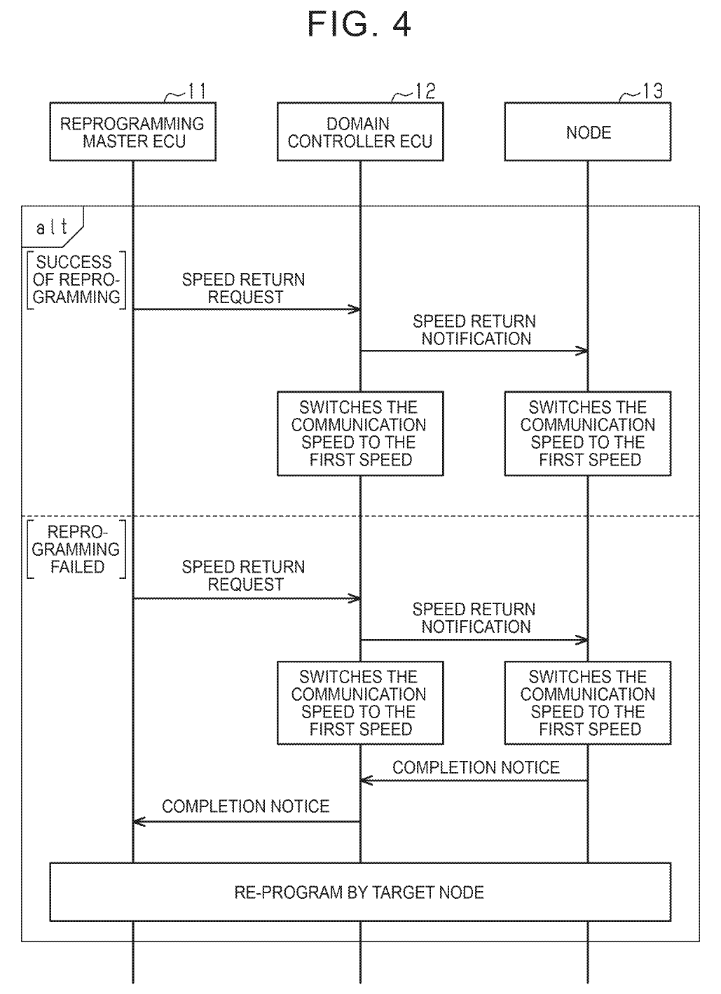

FIG. 4 illustrates an aspect of communication performed in the communication network system 30 after the reprogramming master ECU 11 determines the outcome of the reprogramming of the target node. When the communication speed of the second communication bus 16 is not switched from the first speed to the second speed, the communication of the aspect illustrated in FIG. 4 is not executed.

As illustrated in FIG. 4, when the reprogramming by the target node is determined to be successful, the reprogramming master ECU 11 transmits a speed-return-request to the domain controller ECU 12. The speed return request is a request for switching the speed of communication executed on the second communication bus 16 to which the target node is connected from the second speed to the first speed. The reprogramming master ECU 11 transmits a velocity return request to the domain controller ECU 12 connected to the target node through the second communication bus 16 among the three domain controller ECU 12 included in the communication network system 30.

As illustrated in FIG. 4, the domain controller ECU 12 that has received the speed return request transmits a speed return notification to the node 13. The speed return notification is a notification indicating that the speed of communication executed on the second communication bus 16 is switched from the second speed to the first speed. The domain controller ECU 12 transmits a velocity return notification to all the nodes 13 connected to the second communication bus 16, including the target node.

As shown in FIG. 4, after transmitting the speed return notification, the domain controller ECU 12 switches the speed of communication that it executes through the second communication bus 16 from the second speed to the first speed. As illustrated in FIG. 4, the node 13 that has received the speed return notification switches the speed of communication that it executes through the second communication bus 16 from the second speed to the first speed.

All the nodes 13 connected to the domain controller ECU 12 and the second communication bus 16 switch the communication speed from the second speed to the first speed. As a result, the speed of communication executed on the second communication bus 16 is switched from the second speed to the first speed. In this way, after the reprogramming by the target node is completed, the management device 20 returns the communication speed in the second communication bus 16 from the second speed to the first speed.

As illustrated in FIG. 4, when the reprogramming by the target node is determined to have failed, the reprogramming master ECU 11 transmits a speed-return-request to the domain controller ECU 12 as in the case where the reprogramming has succeeded. The reprogramming master ECU 11 transmits a velocity return request to the domain controller ECU 12 connected to the target node through the second communication bus 16 among the three domain controller ECU 12 included in the communication network system 30.

As illustrated in FIG. 4, the domain controller ECU 12 that has received the speed return request transmits a speed return notification to the node 13 in the same manner as when the reprogramming is successful. The domain controller ECU 12 transmits a velocity return notification to all the nodes 13 connected to the second communication bus 16, including the target node.

As shown in FIG. 4, after transmitting the speed return notification, the domain controller ECU 12 switches the speed of communication that it executes through the second communication bus 16 from the second speed to the first speed.

As illustrated in FIG. 4, the node 13 that has received the speed return notification switches the speed of communication that it executes through the second communication bus 16 from the second speed to the first speed. As illustrated in FIG. 4, the node 13 then transmits a completion notification indicating that the switching of the communication rate is completed to the domain controller ECU 12.

All the nodes 13 connected to the domain controller ECU 12 and the second communication bus 16 switch the communication speed from the second speed to the first speed. As a result, the speed of communication executed on the second communication bus 16 is switched from the second speed to the first speed.

The domain controller ECU 12 switches its communication speed from the second speed to the first speed. At the same time, the domain controller ECU 12 transmits a completion notification to the reprogramming master ECU 11 when receiving the completion notification from all the nodes 13 connected to the second communication bus 16. At this time, the completion notification transmitted by the domain controller ECU 12 indicates that the switching from the second speed to the first speed is completed with respect to the speed of the communication executed on the second communication bus 16.

As illustrated in FIG. 4, after the reprogramming master ECU 11 receives the completion notification, the reprogramming by the target node is executed again. In this way, when the reprogramming by the target node fails, the management device 20 returns the communication speed on the second communication bus 16 to the first speed, and then causes the target node to execute the reprogramming again.

### Operations of Present Embodiment

When transmitting the update data, the management device 20 switches the communication speed on the communication bus to which the target node is connected to the communication bus to a high speed, and transmits the update data to the target node.

### Effects of Present Embodiment

(1) The management device 20 can shorten the time required for updating the program.
(2) The management device 20 confirms the capacity of the update data when the update data is received. When the capacity of the update data is equal to or larger than the predetermined value, the management device 20 switches the speed of communication executed on the communication bus to which the target node is connected to a higher speed. When the capacity of the update data is less than the predetermined value, the management device 20 does not switch the speed of communication executed on the communication bus to which the target node is connected.
   When the communication speed is frequently switched, the stability of communication between the nodes 13 may be hindered. Therefore, it is desirable for the management device 20 to switch the communication speed on the communication bus only when necessary.
   When the capacity of the update data is large, it takes time to update the program. When the capacity of the update data is large, the management device 20 increases the communication speed on the communication bus to which the target node is connected. As a result, the management device 20 can increase the communication speed on the communication bus in order to achieve a situation in which it takes time to update the program.
(3) A threshold value for comparing with the capacity of the update data is determined for each speed of communication executed in the communication bus. The management device 20 confirms the capacity of the update data when the update data is received. In some cases, the capacity of the update data is equal to or greater than a threshold value corresponding to a speed before switching of communication executed on the communication bus to which the target node is connected. At this time, the management device 20 switches the speed of communication executed on the communication bus to which the target node is connected to a higher speed. When the capacity of the update data is less than the threshold value corresponding to the speed before the switching of the communication executed on the communication bus to which the target node is connected, the management device 20 does not switch the speed of the communication executed on the communication bus to which the target node is connected.
   When the communication speed is frequently switched, the stability of communication between the nodes 13 may be hindered. Therefore, it is desirable for the management device 20 to switch the communication speed on the communication bus only when necessary.
   When the capacity of the update data is too large with respect to the communication speed in the communication bus, it takes time to update the program. The management device 20 increases the communication speed in the communication bus when the capacity of the update data is larger than a threshold value determined based on the communication speed before switching in the communication bus to which the target node is connected. As a result, the management device 20 can increase the communication speed on the communication bus in order to achieve a situation in which it takes time to update the program.
(4) The management device 20 confirms the update data when the update data is received. The management device 20 switches the speed of communication executed on the communication bus to which the target node is connected to a higher speed when the update data is full update data that causes the entire update of the program to be performed. The management device 20 does not switch the speed of communication executed on the communication bus to which the target node is connected, when the update data is differential update data that causes the program to be partially updated.
   When the communication speed is frequently switched, the stability of communication between the nodes 13 may be hindered. Therefore, it is desirable for the management device 20 to switch the communication speed on the communication bus only when necessary.
   When the update data is full update data, the program stored in the node 13 needs to be updated entirely, and therefore it takes more time to update the program than when the update data is differential update data. When the update data is full update data, the management device 20 increases the communication speed on the communication bus to which the target node is connected. As a result, the management device 20 can increase the communication speed on the communication bus in view of a situation in which it takes a long time to update the program.
(5) For each speed of communication executed in the communication bus, an upper limit value of the number of devices capable of communication in one communication bus is determined. The number of devices connected to the communication bus to which the target node is connected may be smaller than an upper limit value corresponding to a speed after switching of communication executed on the communication bus to which the target node is connected. In this case, the management device 20 switches the speed of communication executed on the communication bus to which the target node is connected to a higher speed. The number of devices connected to the communication bus to which the target node is connected may be greater than or equal to the upper limit value corresponding to the speed after switching of communication executed on the communication bus to which the target node is connected. In this case, the management device 20 does not switch the speed of communication executed on the communication bus to which the target node is connected.
   The number of devices connected to the communication bus may exceed the number of devices that can communicate at the communication speed after switching. In this case, even when the management device 20 switches the communication speed, the communication speed after the switching may be slower than the speed originally desired to be realized. The management device 20 does not switch the communication speed when the number of devices connected to the communication bus exceeds the number of devices that can communicate at the communication speed after the switching of the communication speed. As a result, the management device 20 can suppress occurrence of a situation in which the switching of the communication speed cannot be targeted.

### Modifications

The above embodiment can be implemented with the following modifications. The above embodiments and the following modifications can be combined with each other within a technically consistent range to be implemented.

The configuration of the communication network system 30 is not limited to the embodiment illustrated in FIG. 1. For example, the communication network system 30 may include only one domain controller ECU 12.

Instead of the reprogramming master ECU 11, the domain controller ECU 12 may determine whether to change the communication rate on the second communication bus 16.

Instead of the domain controller ECU 12, the reprogramming master ECU 11 may determine whether to change the communication rate on the second communication bus 16.

The management device 20 may switch the communication speed at the time of reprogramming the target node without determining whether or not the communication speed in the communication bus needs to be changed.

The condition for determining that the change of the update speed is unnecessary is not limited to the aspect of the above-described embodiment.

For example, the management device 20 may not perform S11 process. That is, when the capacity of the update data is less than the predetermined value, the management device 20 may switch the speed of the communication executed on the second communication bus 16 to which the target node is connected to a higher speed.

For example, the management device 20 may not perform S12 process. That is, when the capacity of the update data is less than the threshold value corresponding to the first speed, the management device 20 may switch the speed of the communication executed on the second communication bus 16 to which the target node is connected to a higher speed.

For example, the management device 20 may not perform S13 process. That is, when the update data is the differential update data, the management device 20 may switch the speed of the communication executed on the second communication bus 16 to which the target node is connected to a higher speed.

The management device 20 may switch the communication speed at the time of reprogramming the target node without determining whether or not to change the communication speed on the communication bus.

The condition for determining that the update speed cannot be changed is not limited to the aspect of the above-described embodiment.

For example, the management device 20 may determine that the communication speed cannot be changed when any of the devices connected to the second communication bus 16 to which the target node is connected fails. For example, the number of devices connected to the second communication bus 16 to which the target node is connected may be equal to or greater than the upper limit value corresponding to the second speed. Regardless of whether or not this is the case, the management device 20 may switch the speed of communication executed on the second communication bus 16 to which the target node is connected to a higher speed without checking the number of devices connected to the second communication bus 16 to which the target node is connected.

The management device 20 is not constituted by the reprogramming master ECU 11 and the domain controller ECU 12, but may be constituted by one device.

The reprogramming by the target node may fail in a state where the communication speed is the second speed. In this case, the management device 20 may switch the communication speed of the second communication bus 16 to a speed higher than the first speed and lower than the second speed, and cause the target node to execute the reprogramming again.

What is claimed is:

1. A management device in a communication network system including a plurality of nodes, the management device being connected to the nodes through a communication bus to manage updating of a program stored in the nodes, and the management device being configured to:
when receiving update data of the program, switch a speed of communication executed through the communication bus to which a target node is connected to a higher speed, the target node being a node for which the program is to be updated, among the nodes; and
after switching the speed of the communication, transmit the update data to the target node.

2. The management device according to claim 1, wherein:
when receiving the update data, the management device checks a volume of the update data;
when the volume of the update data is equal to or more than a prescribed value, the management device switches the speed of the communication executed through the communication bus to which the target node is connected to a higher speed; and
when the volume of the update data is less than the prescribed value, the management device does not switch the speed of the communication executed through the communication bus to which the target node is connected.

3. The management device according to claim 1, wherein:
a threshold value for comparison with a volume of the update data is determined for each speed of the communication executed through the communication bus;
when receiving the update data, the management device checks a volume of the update data;
when the volume of the update data is equal to or more than the threshold value corresponding to the speed, before the switching, of the communication executed through the communication bus to which the target node is connected, the management device switches the speed of the communication executed through the communication bus to which the target node is connected to a higher speed; and
when the volume of the update data is less than the threshold value corresponding to the speed, before the switching, of the communication executed through the communication bus to which the target node is connected, the management device does not switch the speed of the communication executed through the communication bus to which the target node is connected.

4. The management device according to claim 1, wherein:
when receiving the update data, the management device checks the update data;
when the update data are full update data for fully updating the program, the management device switches the speed of the communication executed through the communication bus to which the target node is connected to a higher speed; and
when the update data are differential update data for partially updating the program, the management device does not switch the speed of the communication executed through the communication bus to which the target node is connected.

5. The management device according to claim 1, wherein:
an upper limit value is determined for a number of devices allowed to communicate per communication bus for each speed of the communication executed through the communication bus;
when the number of the devices connected to the communication bus to which the target node is connected is less than the upper limit value corresponding to the speed, after the switching, of the communication executed through the communication bus to which the target node is connected, the management device switches the speed of the communication executed through the communication bus to which the target node is connected to a higher speed; and
when the number of the devices connected to the communication bus to which the target node is connected is equal to or more than the upper limit value corresponding to the speed, after the switching, of the communication executed through the communication bus to which the target node is connected, the management device does not switch the speed of the communication executed through the communication bus to which the target node is connected.
